(19) United States
(12) Patent Application Publication
(10) Pub. No.: US 2022/0128155 A1
(43) Pub. Date: Apr. 28, 2022

(54) ROTOR GATE VALVE

(71) Applicants: Stephen Janse VAN RENSBURG, Benoni (ZA); Barbara Janse Van Rensburg, Johannesburg, Gauteng (ZA)

(72) Inventors: Stephen Janse Van Rensburg, Benoni (ZA); Gert Nel Janse Van Rensburg, (US)

(21) Appl. No.: 17/436,206

(22) PCT Filed: Mar. 4, 2020
(86) PCT No.: PCT/IB2020/051822

§ 371 Date: Sep. 3, 2021

(30) Foreign Application Priority Data
Mar. 4, 2019 (ZA) 2019/01338

(51) Int. Cl. F16K 3/02; F16K 3/06; F16K 3/12; F16K 3/18

(52) U.S. Cl. CPC F16K 3/0254; F16K 3/18; F16K 3/12; F16K 3/06

(57) ABSTRACT

This invention relates to a rotor gate valve 10 for use in high-pressure slurry systems. The valve 10 comprises a valve housing 12 defining a flow passage 14 therethrough for operatively receiving a fluid and an annular valve seat 16 of resilient material which is removably secured against the inner periphery of the flow passage 14.

### FIELD OF THE INVENTION

This invention relates to a rotor gate-type valve. More particularly, but not exclusively, this invention relates to a rotor gate-type valve for use in high-pressure slurry systems.

### BACKGROUND TO THE INVENTION

Gate valves are well known and generally comprise a plate-like closure that is displaceable, transversely to a fluid flow passage of the valve, between a closed position, wherein the closure overlies the flow passage and closes it, whereby fluid is prevented from flowing past the closure in the flow passage, and an open position, wherein the closure is displaced, at least partially, from the flow passage whereby the flow passage is, at least partially, open and fluid is permitted to flow therein past the closure.

Conventional gate valves suffer from the disadvantage that with time dirt tends to build up on the leading edge of the closure and relatively high wear is experienced on the leading edge. As a result, with time, sealing of the valve becomes problematic.

In order to address the above disadvantages, it is known to fit gate valves with a closure that is mounted for at least partial angular movement. This enables the closure to seat in different angular positions in the flow passage when it is in its closed position.

A drawback associated with known gate valves that have a rotatable closure is that the closure seats against the inner wall of the flow passage, which is covered with an abrasion resistant lining. With time, the closure damages the lining which causes the seal between the closure and inner wall to be compromised. These valves then need to be replaced with new ones, even though the rest of the valve may still be in good working order.

### OBJECT OF THE INVENTION

It is accordingly an object of the present invention to provide a rotor gate valve which, at least partially, alleviates the abovementioned disadvantage, and/or to provide a rotor gate valve which is a useful alternative to known rotor gate valves.

### SUMMARY OF THE INVENTION

According to the invention, there is provided a valve comprising:
a valve housing defining a fluid flow passage therethrough for operatively receiving a fluid;
an annular seat being removably secured against the inner periphery of the flow passage;
a valve closure which is progressively displaceable, transversely to the flow passage, between a closed position, wherein the closure overlies and engages the valve seat to close the flow passage, whereby fluid is prevented from flowing past the closure in the flow passage, and an open position, wherein the closure is displaced from at least a portion of the valve seat whereby the flow passage is, at least partially, open and fluid is permitted to flow therein past the closure; and
a displacement mechanism for displacing the closure between its respective open and closed positions, the closure being connected to the displacement mechanism to permit at least partial angular movement.

The valve closure may be located operatively downstream from the valve seat.

The seat may comprise a sleeve having a first end for operatively sealingly engaging the closure, and an opposing second end having a flange that projects radially outwardly from a remainder of the sleeve for seating against an annular shoulder of the valve housing in order to restrict movement of the seat along the flow passage. The first end may taper from the inner periphery to the outer periphery, in a direction towards the second end.

There is further provided for the valve to include a retaining ring that is removably securable over the seat and against the valve housing whereby the seat flange is sandwiched between the retaining ring and valve housing in order to retain the seat in position against the valve housing. According to an example embodiment of the invention, the retaining ring is removable securable to the valve housing by means of one or more fasteners. The retaining ring may be securable to a mounting formation defined on the valve housing about the flow passage for connecting the valve to other components of a high-pressure slurry system.

The seat may be of resilient material.

A further feature of the invention provides for a wedge arrangement whereby a component of movement in a direction along the flow passage is imparted to the closure upon closing movement thereof, to ensure that the closure becomes tightly wedged against the valve seat in its closed position. The wedge arrangement could comprise an annulus which is secured to the downstream side of the closure and which is adapted to engage an angled surface to provide a wedging action. The surface is angled in a downstream direction from a widest portion where the closure enters the flow passage during closing; to a narrowest portion at the zone where the leading end of the closure is disposed once the valve is fully closed. The angled surface could for example be formed by the wall of the flow passage.

The closure may be in the form of a plate-like body.

The valve closure may be axially progressively displaceable.

These and other features of the invention are described in more detail below.

### BRIEF DESCRIPTION OF THE ACCOMPANYING DIAGRAMS

One embodiment of the invention is described below, by way of a non-limiting example only, and with reference to the accompanying drawings wherein:

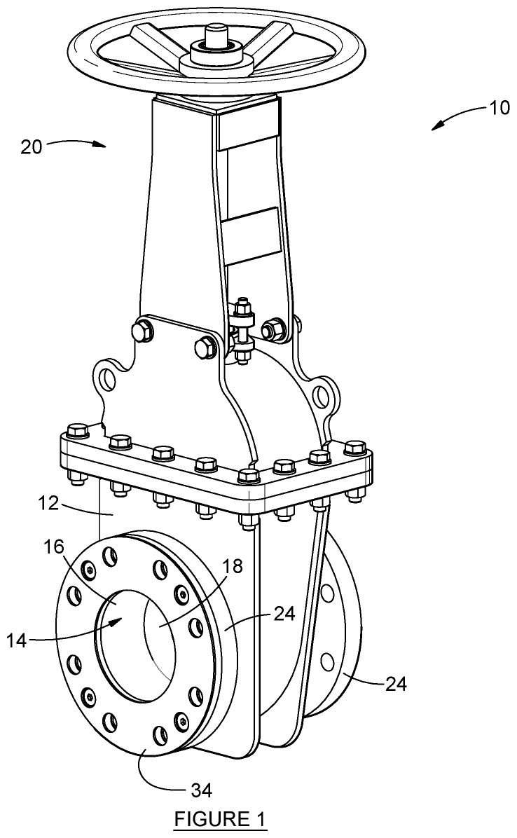

FIG. 1 shows a schematic perspective view of a rotor gate valve in accordance with the invention;

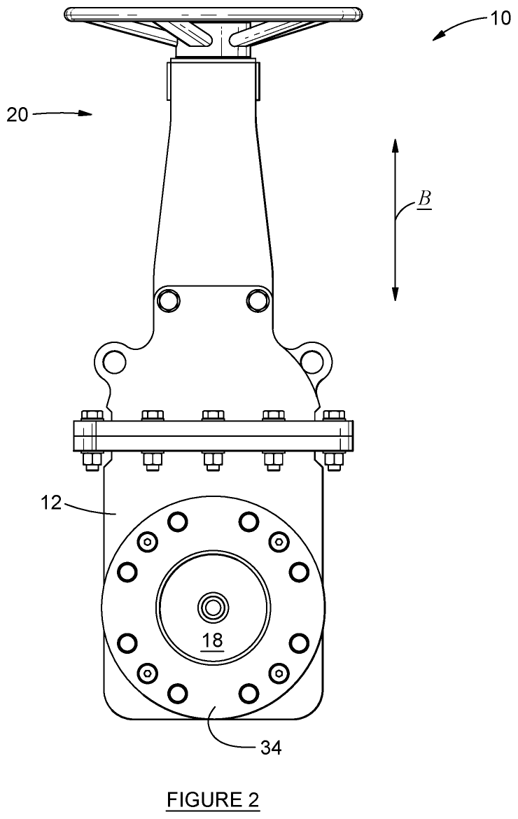

FIG. 2 shows a schematic side elevation of the valve of FIG. 1;

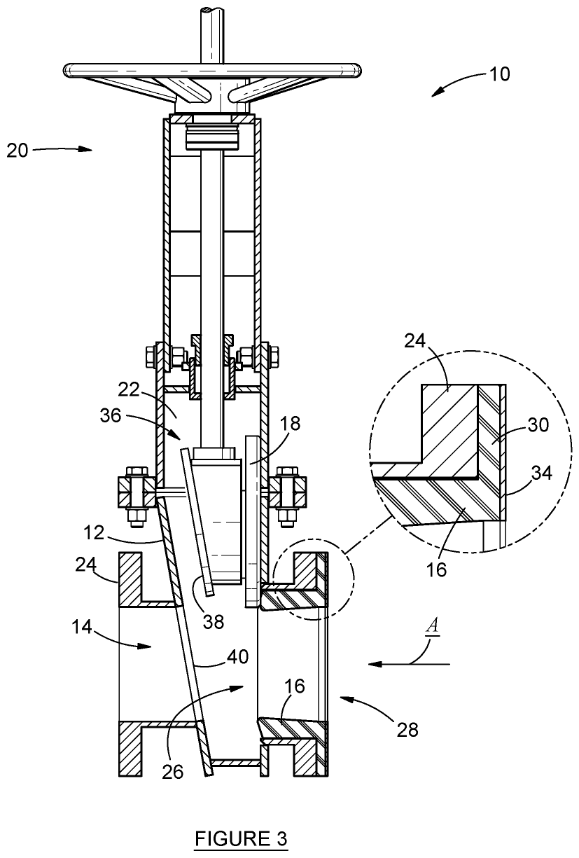

FIG. 3 shows a schematic sectioned end elevation of the valve of FIG. 1 with a closure thereof in a fully open position;

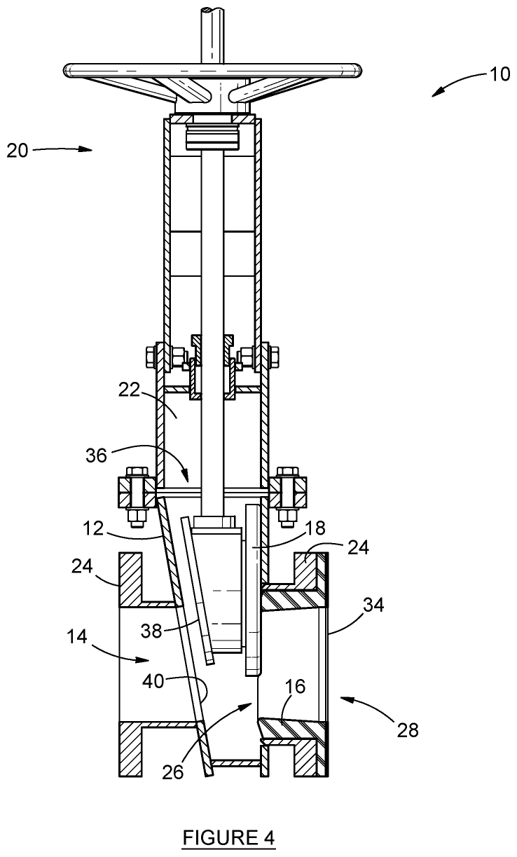

FIG. 4 shows a schematic sectioned end elevation of the valve of FIG. 1 with the closure in a partially open position; and

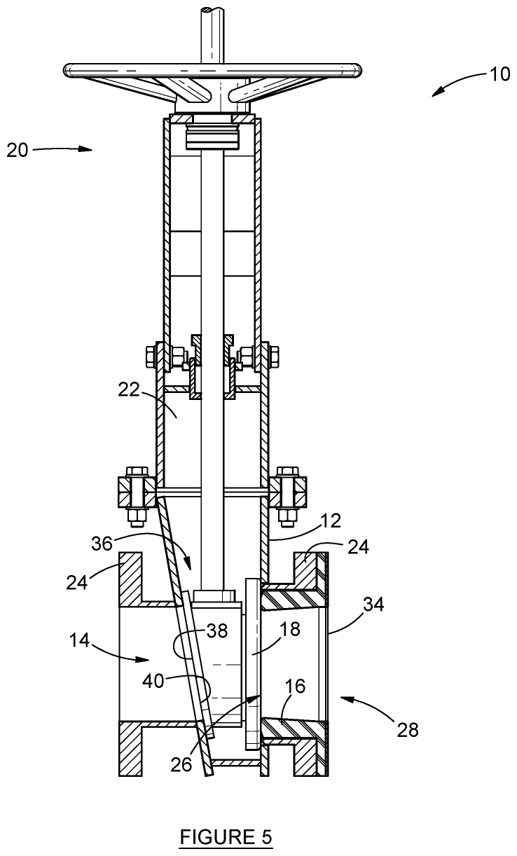

FIG. 5 shows a schematic sectioned end elevation of the valve of FIG. 1 with the closure in a closed position.

### DETAILED DESCRIPTION OF AN EXAMPLE EMBODIMENT OF THE INVENTION

Referring to the accompanying Figures, a rotor gate valve, in accordance with the invention, is generally designated by reference numeral 10.

The valve 10 is generally used in high-pressure slurry systems (not shown) and comprises a valve housing 12 defining a flow passage 14 therethrough for operatively receiving a fluid (not shown) from a direction indicated by reference numeral A in FIG. 3, and an annular valve seat 16 of resilient material which is removably secured against the inner periphery of the flow passage 14.

The valve 10 further includes a valve closure 18 in the form of a plate-like body, located operatively downstream from the valve seat 16, which is axially progressively displaceable B (in FIG. 2), transversely to the flow passage 14, between a closed position (shown in FIG. 5) and an open position (shown in FIG. 3). With the closure 18 in its closed position, it overlies the flow passage 14 and closes it, whereby fluid is operatively unable to flow past the closure 18 in the flow passage 14. On the other hand, with the closure 18 in its open position, it is retraced from at least a portion of the flow passage 14 whereby the flow passage 14 is open and fluid is operatively permitted to flow therein past the closure 18. Preferably, when the closure 16 is in a fully open position, the flow passage 14 is open and no part of the closure 18 obstructs the flow passage 14.

The valve 10 further includes a displacement mechanism 20 that is secured to the valve housing 12 and connected to the valve closure 18 for progressively displacing the closure 18, relative to the housing 12, between its respective open and closed positions in a well-known manner. With the valve 10 in an operatively upright position, the displacement mechanism 20 is adapted to lift and lower the closure 18 between its respective positions. The valve closure 18 is connected to the displacement mechanism 20 to permit at least partial angular movement thereof relative to the mechanism 20. More specifically, the valve closure is angularly movable about an axis extending along a direction along the flow passage 14. Although the mechanism 20 is illustrated to be a hand-operated mechanism, it should be appreciated that in other embodiments of the invention, the mechanism 20 could be an automated mechanism (pneumatic- or hydraulically-operated), electric, bevel gearbox mechanism, or the like.

The valve housing 12 defines a closure cavity or slot 22 therein that is orientated transverse to the flow passage 14 and provides a space where the valve closure 18 is displaceable in. Mounting formations 24 are defined on opposing sides of the valve housing 12, about the flow passage 14, which could be connected to other components (not shown), including conduits, of the high-pressure slurry system. In another example embodiment of the invention, the mounting formations 24 could be in the form of flanges.

The seat 16 comprises a sleeve 16 having a first end 26 for operatively sealingly engaging the closure 18 when it is in its closed (or partially closed) position so to seal the flow passage 14, and an opposing second end 28 having a flange 30 that projects radially outwardly from a remainder of the sleeve 16 and abuts an axial outer surface of the mounting formation 24 located at a corresponding side of the valve housing 12 in order to restrict axial movement of the seat 16 along the flow passage 14. The first end 26 tapers from the inner periphery to the outer periphery, in a direction towards the second end 28. As shown, the first end 26 protrudes into the slot 22 whereby it is able to sealing engage the valve closure 18 when in its closed position.

The valve 10 also includes a retaining ring 34 that is removably securable over the seat 16 and against the valve housing 12, more specifically against the mounting formation 24, whereby the seat flange 30 is sandwiched between the retaining ring 34 and mounting formation 24 in order to retain the seat 16 in position. According to an example embodiment of the invention, the retaining ring 34 is removable securable to the valve housing 12 by means of one or more fasteners (not shown).

A wedge arrangement 36 is further provided whereby a component of movement along the flow passage 14 is imparted to the closure 18 upon closing movement thereof, to ensure that the closure 18 becomes tightly wedged against the valve seat 16 in its closed position. The wedge arrangement 36 comprise an annulus 38 which is secured to the downstream side of the closure 18 and which is adapted to engage an angled surface 40 to provide a wedging action. The surface 40 is angled in a downstream direction from a widest portion where the closure 18 enters the flow passage 14 during closing; to a narrowest portion at the zone where the leading end of the closure 18 is disposed once the valve 10 is fully closed. The angled surface 40 could for example be formed by the wall of the flow passage 14.

In use, the valve 10 is connected, via mounting formations 24, in a high-pressure liquid system (not shown) in order to permit fluid (not shown) to flow through the flow passage 14 when the closure 18 is in its open position. When it is required to prevent the fluid from flowing through part of the system where the valve 10 is located, the displacing mechanism 20 is utilised to displace the closure 18 to its closed position to close the passage 14.

It is envisaged that the invention teaches a solution whereby, firstly, it is no longer necessary for rotor gate valves to seal against an inner wall of the valve housing and, secondly, once the sealing arrangement has been compromised, it is no longer necessary to discard the entire valve as the damaged valve seat can now be removed and replaced with a new one within a relatively short space of time. Added to this, the wedging action imparted by the wedging arrangement 36 to the closure 18, urges the closure 18 axially against the seat 16 to ensure that the closure becomes tightly wedged and forms a tight seal against the valve seat 16 in its closed position.

It will be appreciated by those skilled in the art that the invention is not limited to the precise details as described herein and that many variations are possible without departing from the scope of the appended claims. As such, the present invention extends to all functionally equivalent structures, methods and uses that are within its scope.

The description is presented by way of example only in the cause of providing what is believed to be the most useful and readily understood description of the principles and conceptual aspects of the invention. In this regard, no attempt is made to show structural details of the invention in more detail than is necessary for a fundamental understanding of the invention. The words which have been used herein are words of description and illustration, rather than words of limitation.

1. A valve comprising:
a valve housing defining a fluid flow passage therethrough for operatively receiving a fluid;
an annular seat being removably secured against the inner periphery of the flow passage;
a valve closure which is progressively displaceable, transversely to the flow passage, between a closed position, wherein the closure overlies and engages the valve seat to close the flow passage, whereby fluid is prevented from flowing past the closure in the flow passage, and an open position, wherein the closure is displaced from at least a portion of the valve seat whereby the flow passage is, at least partially, open and fluid is permitted to flow therein past the closure; and
a displacement mechanism for displacing the closure between its respective open and closed positions, the closure being connected to the displacement mechanism to permit at least partial angular movement.

2. The valve according to claim 1, wherein the valve closure is located operatively downstream from the valve seat.

3. The valve according to claim 1, wherein the seat comprises a sleeve having a first end for operatively sealingly engaging the closure, and an opposing second end having a flange that projects radially outwardly from a remainder of the sleeve for seating against an annular shoulder of the valve housing in order to restrict movement of the seat along the flow passage.

4. The valve according to claim 3, including a retaining ring that is removably securable over the seat and against the valve housing whereby the seat flange is sandwiched between the retaining ring and valve housing in order to retain the seat in position against the valve housing.

5. The valve according to claim 1, wherein the seat is of resilient material.

6. The valve according to claim 1, including a wedge arrangement whereby a component of movement in a direction along the flow passage is imparted to the closure upon closing movement thereof, to ensure that the closure becomes tightly wedged against the valve seat in its closed position.

7. The valve according to claim 6, wherein the wedge arrangement comprises an annulus which is secured to the downstream side of the closure and which is adapted to engage an angled surface to provide a wedging action.

8. The valve according to claim 7, wherein the angled surface is formed by the wall of the flow passage.

9. The valve according to claim 1, wherein the closure is in the form of a plate-like body.
